(19) United States
(12) Patent Application Publication
(10) Pub. No.: US 2018/0130091 A1
(43) Pub. Date: May 10, 2018

(54) Determining Marketing Campaigns Based On Customer Transaction Data

(71) Applicant: Justin Rae, Riverton, UT (US)

(72) Inventor: Justin Rae, Riverton, UT (US)

(21) Appl. No.: 15/805,914

(22) Filed: Nov. 7, 2017

Related U.S. Application Data
(60) Provisional application No. 62/419,368, filed on Nov. 8, 2016.

(51) Int. Cl. G06Q 30/02

(52) U.S. Cl. CPC G06Q 30/0246

(57) ABSTRACT

Methods and systems for determining marketing campaigns for customers based on customer transaction data are described. In one or more implementations, the customers are assigned to consumer classes based on respective customer values and activity levels. Appropriate marketing campaigns are generated and output for each user based on the assigned consumer class.

### PRIORITY/CROSS-REFERENCE TO RELATED APPLICATIONS

This application claims the benefit of U.S. Provisional Application No. 62/419,368, filed Nov. 8, 2016, the disclosure of which is incorporated by reference.

### BACKGROUND

Marketing campaigns (“campaigns”) such as postal mail advertisements, emails, phone calls, text messages, and customer loyalty rewards are typically provided to customers to increase a likelihood that the customers will purchase a product or service from a business. When a campaign successfully influences a customer to purchase a product or service, the business can minimize expenditures, maximize revenue, establish customer loyalty, and so on. Traditionally, a business may send out the same campaign to all current and potential customers. While this technique may have limited success, it fails to account for comparative monetary values and behaviors of the customers. Accordingly, traditional marketing techniques fail to account for such variances within the marketing audience, and thus, lead to unsatisfactory results.

### SUMMARY

Techniques and systems are described for determining marketing campaigns based on customer transaction data. A digital medium environment is configured to collect customer transaction data that describes customer transaction histories, e.g. past purchases, for a plurality of customers in order to determine appropriate campaigns for the respective customers. The transaction data is used to assign a consumer class for each customer that is based on a value determination and a current activity level of the customer. The value determination is indicative of how loyal the customer is and how much money the customer has spent historically. The activity level is indicative of whether behavior of the customer conforms to, or varies from, historical transaction patterns or predicted transaction patterns. For example, a customer may be identified as being within a consumer class pertaining to top 15% customer value and having an inactive activity level based on a strong variance from historical transaction patterns. Based on the identified consumer class, the system is able to identify and output a tailored marketing campaign for similar costumers. By doing so, a business can deliver customized campaigns that are more likely to result in desired actions by the customers.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to determine marketing campaigns based on customer transaction data as described herein.

FIG. 2 depicts a customer evaluation module of FIG. 1 in greater detail.

FIG. 3 depicts three example scenarios based on three example customers.

FIG. 4 is a flow diagram depicting a procedure in an example implementation in which marketing campaigns are determined based on customer transaction data.

FIG. 5 illustrates an example system usable to implement the techniques described herein.

### DETAILED DESCRIPTION

### Overview

The use of “e.g.,” “etc,” “for instance,” “such as,” “in example,” “for example,” and “or” and grammatically related terms indicates non-exclusive alternatives without limitation, unless the context clearly dictates otherwise. The use of “including” and grammatically related terms means “including, but not limited to,” unless the context clearly dictates otherwise. Similarly, the use of “indicative” and grammatically related terms means “maybe representative of, but not limited to,” unless the context clearly dictates otherwise. The use of the articles “a,” “an” and “the” are meant to be interpreted as referring to the singular as well as the plural, unless the context clearly dictates otherwise. Thus, for example, reference to “a campaign” includes two or more such campaigns, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment. Words of approximation (e.g., “substantially,” “generally”), as used in context of the specification and figures, are intended to take on their ordinary and customary meanings which denote approximation, unless the context clearly dictates otherwise.

Conventional marketing techniques using generic campaigns lack sufficient customization to be useful as a basis for maintaining or gaining revenue. As previously described, this may be caused by an inability of these conventional techniques to adapt and select appropriate campaigns for individual customers. The lack of individualized campaigns may result in lower returns on investments (ROIs) on marketing efforts, which can lead to decreased profits for businesses.

Techniques and systems are described that generate a campaign or select the campaign from a group of campaigns for a customer based on customer transaction data for the customer. A consumer class is selected for the customer based on the customer transaction data specific to the customer. In order to do so, the techniques include determining a value and a current activity level for the customer. The value determination is indicative of how loyal the customer is and how much money the customer has spent historically. The activity level is indicative of whether behavior of the customer conforms to, or varies from, historical transaction patterns or predicted transaction patterns. Continuing the example above, the techniques may include selecting a very aggressive campaign for a customer that is identified as being within a consumer class for the top 15% of customer value and inactive activity level. By targeting marketing campaigns based on customer transaction histories and behaviors, a business can increase marketing ROIs as well as general revenue through sales.

In the following discussion, campaigns refer to content provided to users related to marketing activities performed, such as to increase awareness and conversion of products or services made available by a product or service provider, e.g., a business. Accordingly, campaigns may take a variety of forms, such as emails, advertisements included in postal mail, phone calls, text messages, and customer loyalty rewards.

An example environment is first described that may employ the techniques for determining marketing campaigns described herein. Example procedures are then described which may be performed in the example environment as well as other environments. Consequently, performance of the example procedures is not limited to the example environment and the example environment is not limited to performance of the example procedures.

### Example Environment

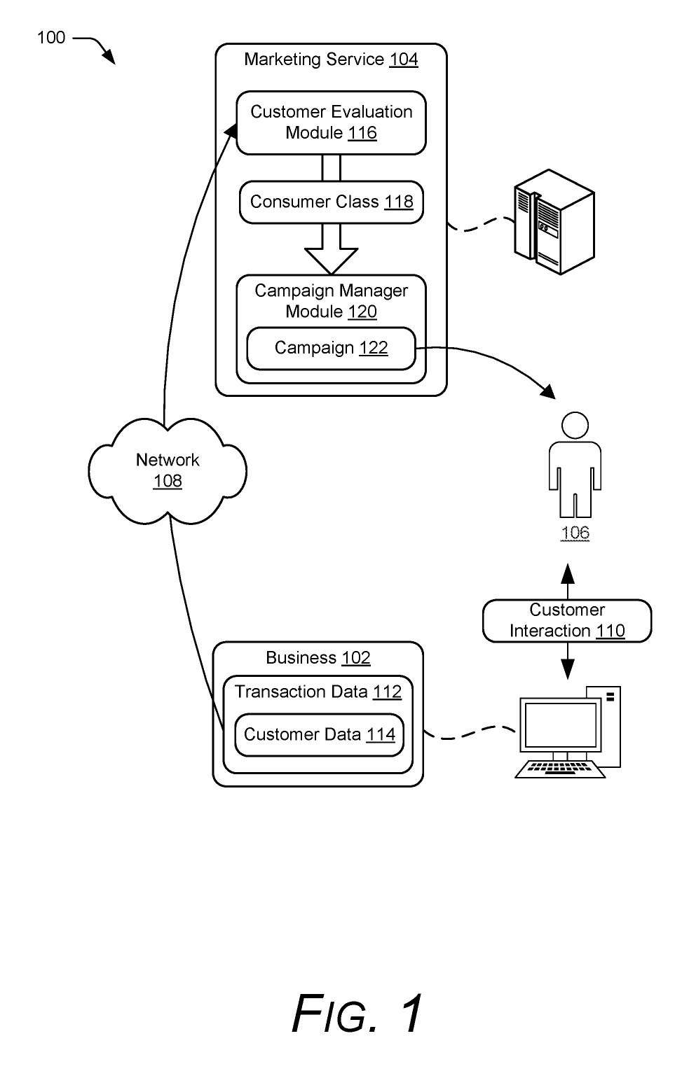

FIG. 1 is an illustration of a digital marketing environment 100 in an example implementation that is operable to employ campaign determination techniques described herein. The illustrated environment 100 includes a business 102, a marketing service 104, and a customer 106 that are communicatively coupled, one to another, via a network 108. The business 102 may be indicative of a single store or website, a string of stores, or even multiple different businesses. The customer 106 and the business 102 provide customer interaction 110 including, for example, transactions including purchases of products or services, signing up for a marketing list, physical interaction, phone calls, etc. The customer interaction 110 generates transaction data 112 that is indicative of interactions between the customer 106 and the business 102 as well as other customers and the business 102.

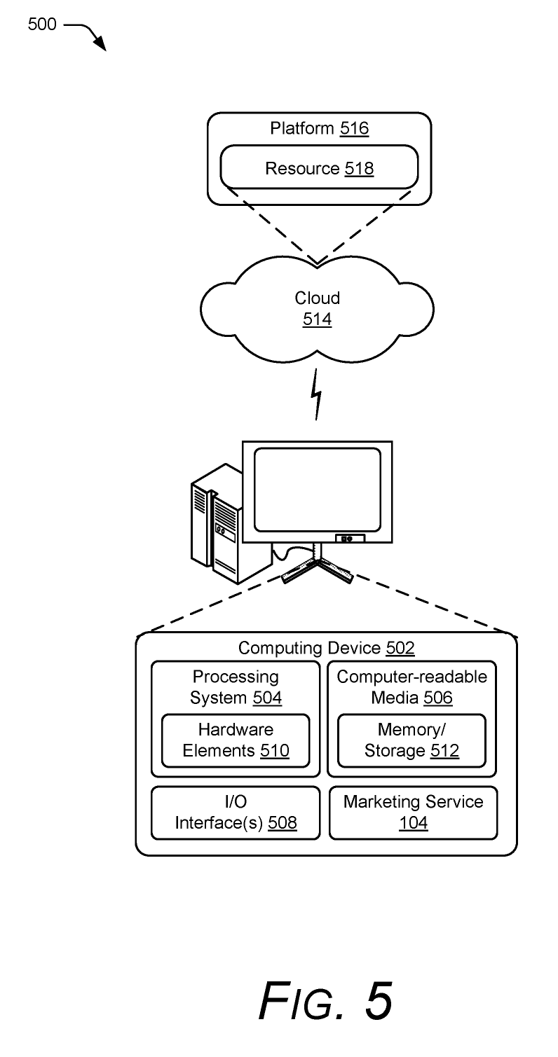

The network 108 may include any suitable communication technology, such as an internal or external bus, a wireless network, a wired network, or any combination thereof. A computing device used to implement the business 102 may be configured to include a desktop computer, a laptop computer, a mobile device, a point of sale device, a cash register, a receipt reading device, etc. Any device capable of collecting and/or generating the transaction data 112 may be used. For example, the computing device corresponding to the business may include a receipt reader that is able to generate the transaction data 112 by collecting data, such as one or more of a customer identification, a transaction date, a value of the transaction, or items and services purchased in the transaction. A computing device used to implement the marketing service 104 may range from a full resource device with substantial memory and processor resources (e.g., a personal computer or a server) to a relatively low-resource device with limited memory and/or processing resources (e.g., a mobile device). Additionally, a computing device (used to implement the business 102 and/or the marketing service 104) may be representative of a plurality of different devices, such as multiple servers utilized by a business to perform operations “over the cloud” as further described in relation to FIG. 5. Although shown as separate devices, the marketing service 104 may also be integrated within the business 102, further divided among other entities, implemented on a remote server, or implemented on a same computing device as the computing device used to implement the business 102.

The marketing service 104, which is implemented at least partially in hardware, is representative of functionality to analyze the transaction data 112 including customer data 114 (specific to customer 106) from the business 102. Again, the transaction data 112 is indicative of past transactions of multiple customers with the business 102 (e.g. dates of transactions, dollars spent, products or services purchased, time spent). The customer data 114, which is contained within the transaction data 112, is indicative of transaction data that is specific to the customer 106.

The marketing service 104 includes a customer evaluation module 116 implemented at least partially in hardware to receive and analyze the transaction data 112, including customer data 114, in order to determine a consumer class 118 for the customer 106. The consumer class 118 may be specific to the customer 106 or may be associated with other customers, depending on the transaction data 112 and/or how many consumer classes are being used.

The marketing service 104 also includes a campaign manager module 120 implemented at least partially in hardware to match the determined consumer class 118 with an appropriate campaign 122 and output the campaign 122 for exposure to the customer 106. Further descriptions of the customer evaluation module 116 and the campaign manager module 120 are included in the following description.

The campaign 122, that is selected from a plurality of campaigns, may be any type of physical or electrical communication, such as, a postal advertisement, email, text message, phone call, deposit of reward points, etc. The campaign 122 may also comprise a plurality of such communications, e.g. multiple emails or an email and a text message. Examples of campaigns are percentage discounts, monetary discounts, free products or services, free amenities, rewards points, preferential scheduling, and so on.

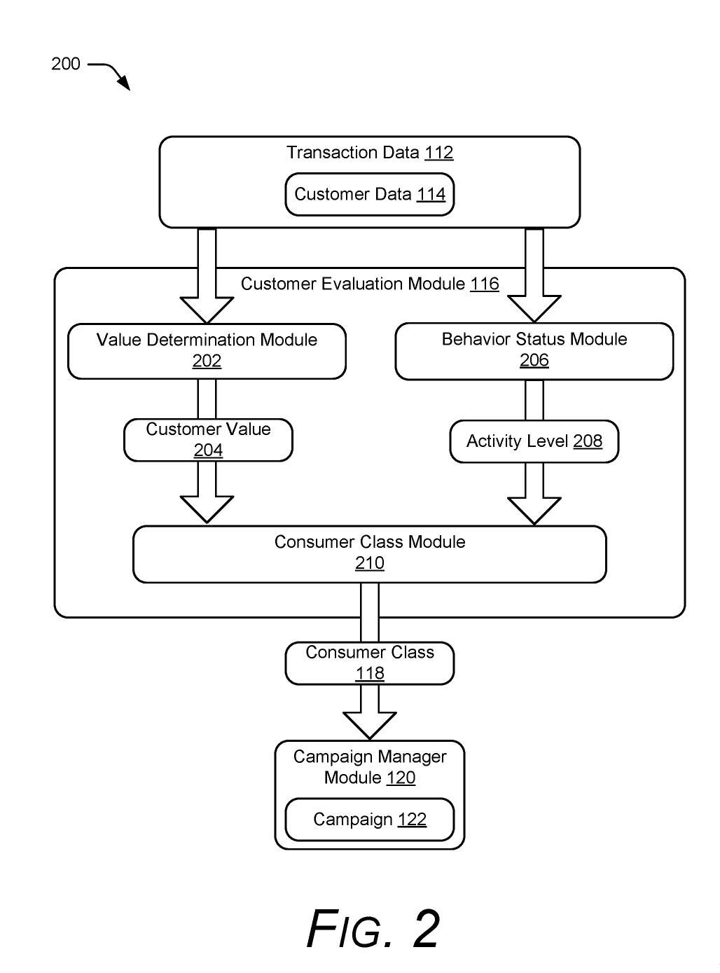

FIG. 2 depicts a system 200 in an example implementation showing operation of the customer evaluation module 116 of FIG. 1 in greater detail. The customer evaluation module 116 processes the transaction data 112, including the customer data 114, to determine the consumer class 118 for the customer 106 such that the campaign manager module 120 can output the campaign 122 (associated with the consumer class 118). As discussed above, the consumer class 118 is one of a plurality of consumer classes that may comprise value and activity components. Some examples of consumer classes are top 15% value and inactive, top 15% value and active, 15-30% value and inactive, 15-30% value and active, 90-100% and inactive, and 90-100% and active. To determine the consumer class 118 for the customer 106, the customer evaluation module 116 includes a value determination module 202 to provide a customer value 204, a behavior status module 206 to provide an activity level 208, and a consumer class module 210 to analyze the customer value 204 and the activity level 208.

### Customer Value

The value determination module 202, which is implemented at least partially in hardware, receives the transaction data 112 and determines the customer value 204 based on purchase amounts and/or purchase frequencies for the customer 106. A purchase amount may include one or more of a lifetime amount of money paid by the customer during transactions, an amount of money paid by the customer during a previous period of time (e.g., previous year or previous quarter), an amount of money paid by the customer during the most recent transaction of the customer, or a projected amount of money to be paid by the customer during a period of time. A purchase frequency may simply be determined based on how often the customer 106 made purchases at the business 102.

In order to do so, the customer data 114, including dollar values and frequencies of transactions of the customer 106 are analyzed. Parameters measured from the customer data 114 are used to build a probability distribution such as a Poisson, binomial or Gaussian distribution or a fully empirical distribution.

Some such implementations involve calculating a mean rate of transactions for the customer 106 for a given time interval. This mean rate can be used as a parameter in a Poisson probability distribution extrapolation that gives a probability of the customer 106 completing a certain quantity of transactions (Pₜ) in a future time period given the observed mean rate of transactions, as shown in equation 1.

$${P}_{t} = {e}^{- τ} \frac{{τ}^{k}}{k !} \qquad ( 1 )$$

Where e is Euler's number, τ is the mean rate of transactions for the given time interval, and k is the predicted quantity of transactions (0, 1, 2, . . . )

The probability distribution is integrated on an interval from a certain quantity of transactions to infinity resulting in a cumulative distribution that describes the probability of the customer 106 completing a certain quantity of transactions or more within a giving time period, as shown in equation 2.

P_{cum}(x)=∫ₓ^{∞}Pₜ(t)dt (2)

A threshold confidence level is then chosen (e.g., 80%) that the customer 106 will complete a certain quantity of transactions. The corresponding quantity of transactions associated with this threshold confidence level will be taken as the predicted transaction frequency (PTF) for the customer 106 as shown in equation 3.

PTF=x where P_{cum}(x)≥confidence level threshold (3)

A similar approach is used to generate a predicted dollar spending (PDS) and a predicted transaction frequency (PTF) for the customer 106. The PDS and PTF are then consolidated into the customer value 204 (CV) by weighting the contribution of each by some predetermined value, as shown in equation 4.

W₁*PTF+AW₂*PDS=CV (4)

The customer values of a plurality of customers are examined similarly and ranked relative to one another to determine value segments (groups) based on various predefined segmentation criteria, as shown in equation 5.

W₁*PTF+AW₂*PDS=CV (5)

In some implementations, groupings are determined based on natural occurring divisions, or clusters, among the customers. In other implementations, groupings are based on statistical evaluations of the customer transactions, such as groupings based on standard deviations from an average value. In other implementations, groupings are based on percentile groupings, e.g., first quartile, second quartile, third quartile, and fourth quartile of purchase amounts and/or frequencies. The customer value 204 may then be based on one of the groups that the customer 106 falls into.

### Activity Level

The behavior status module 206, which is implemented at least partially in hardware, receives the customer data 114 and determines an activity level 208 for the customer 106 based at least in part on transaction timing. The behavior status module 206 may generate an expected interaction projection including a timeline of expected interactions and expected amounts to be paid by the customer 106. The behavior status module 206 can then monitor the customer data 114 for variation from the expected interaction projection for the customer 106. Based at least in part on variation from the interaction projections, the activity level 208 may be assigned to the customer 106. For example, if the customer 106 has had a generally consistent interval between transactions, the customer 106 may be considered as “active.” Alternatively, if the customer 106 has varied from the interaction projections, the customer 106 may be considered as “inactive.”

Variation from the interaction projections may be sufficient to trigger an inactive status based on a threshold variation. For example, if the customer 106 has an associated interaction projection of making a purchase on a three-month interval, a threshold variation may be set for one month. Thus, after four months pass from a most-recent transaction, the customer 106 is considered as “inactive.” The threshold variation may be sized based on, for example, a length of a regular interval of the interaction projection or an amount of expected money spent during a projected transaction. Additionally or alternatively, the variation threshold may be based on a percentage of a length of a regular interval of the interaction projection. In some implementations, the variation threshold is one of 10%, 20%, 25%, 33%, 50%, or 100% of the length of the regular interval of the interaction projection.

### Consumer Class

The consumer class module 210, which is implemented at least partially in hardware, receives the customer value 204 and the activity level 208 and generates the consumer class 118 for the customer 106. The consumer class 118 indicates a value of the customer 106 and whether a trend in behavior has been indicated. The consumer class 118 is then sent to the campaign manager module 120 such that the campaign 122 (associated with consumer class 118) may be output for exposure to the customer 106.

The consumer classes may be dynamically calculated as the marketing service 104 receives additional customer data from new or existing customers. The additional customer data may move a customer from one consumer class to another consumer class, or may change criteria defining one or more consumer class. For example, if consumer classes are defined via a statistical calculation based on values of multiple customers, a change in behavior of one or more customers may affect the statistical calculations.

### Campaign Generation/Selection

The campaign manager module 120 may select the campaign 122 from a plurality of campaigns based on the consumer class 118 for the customer 106. In some implementations, the campaign 122 is standardized for a plurality of customers within the consumer class 118. Thus, the plurality of campaigns may be pre-generated based on pre-determined consumer classes. For example, if a consumer class of customers is determined to respond to campaigns based on dollar amount discounts, then dollar amount discount campaigns will be associated with that consumer class. If another consumer class of customers is determined to respond to free products or services, then free product or service campaigns will be associated with that consumer class. Another consumer class of customers may be motivated by campaigns directed towards free services such as in-store babysitting, free food, or live music. Marketing campaigns may be associated with a consumer class through testing, e.g. by exposing the customers to free service campaigns and monitoring future transactions. The campaign manager module 120 may also generate campaign/consumer class associations that are based on appropriate marketing channels and forms of media that are specific to the respective consumer classes.

Alternatively or additionally, the campaign 122 may be selected in real-time. For example, if the customer 106 communicates with the business 102, in person or through a device, the campaign manager module 120 may receive an input as to whether the transaction is of particular importance. In more detail, if the customer 106 complains about a previous interaction with the business 102, the business 102 may request, from the campaign manager module 120, a determination of the campaign 122 that that is very aggressive (high discount, free products, etc.). If the customer value 204 and the activity level 208 are low, the marketing service 104 may select no campaign at all. Conversely, if one or both of the customer value 204 or the activity level 208 are high, the campaign 122 may include a credit or a discount to maintain loyalty and retain the value of the customer.

The campaign 122 may also comprise or be integrated with an advertising distribution system or rewards service. For example, if the customer 106 spends $25, the campaign 122 may comprise a coupon for a free product or service. However, the campaign 122 may include varying spending thresholds or varying coupons based on the consumer class 118. In the case of an external advertising distribution system or rewards service, the campaign manager module 120 may output lists of customers and determined campaigns such that the remote advertising distribution system or rewards service can update rewards or expose the campaigns to respective customers.

In some implementations, the campaign 122 may be based on items purchased. For example, if the customer 106 has historically ordered all, or above a threshold amount, of items on a menu, the campaign 122 may include a coupon or other offer based on the customer value 204 in conjunction with the behavior of trying all menu items. More specifically, the campaign 122 may include a coupon for a new item on the menu. In another implementation, if the customer 106 exceeds a threshold transaction frequency, the campaign 122 may comprise a coupon or other offer based on the customer value 204 in conjunction with the behavior of passing the transaction threshold. Thus, when customer behavior for the customer 106 triggers a metric, the campaign 122 may be automatically generated and delivered to the customer, the content of which being based on the customer value 204, the consumer class 118, and/or other customer transaction data-derived calculation.

Although described in terms of a single customer and a single campaign, the systems above may be used to select appropriate campaigns for any subset of the customers within the customer transaction data (including the entire group of customers). Furthermore, multiple campaigns, either in conjunction or sequentially, may be generated for a single customer based on the customer data 114 for the customer. As new customer transaction data is obtained, the marketing service 104 may update consumer classes, customer value thresholds, activity level thresholds, potential marketing campaigns and associations with consumer classes, transactions with rewards systems, metric triggering conditions, and so on.

### Example Implementations

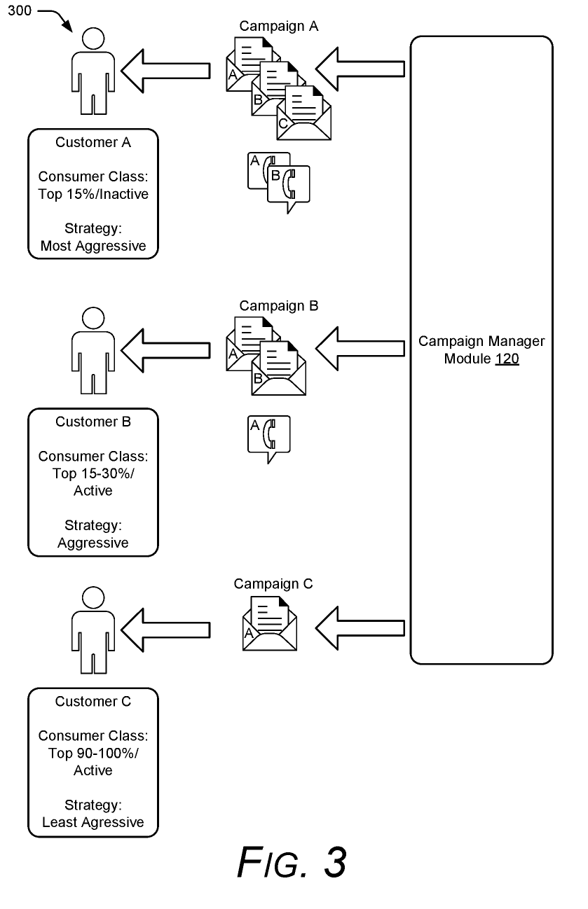

FIG. 3 illustrates at 300 three example customers with different consumer classes. The three customers have different consumer classes based on differing customer data 114. Customer A has been identified, for example by the customer evaluation module 116, as falling within a top 15% and inactive consumer class. Based on the top 15% and inactive consumer class, campaign manager module 120 selects Campaign A for exposure to Customer A. In this case, a most aggressive strategy has been selected for the top 15% and inactive consumer class. Although shown as comprising messages A, B, and C along with phone communications A and B, Campaign A may comprise any number of messages or communications including a single communication (for example with a high discount representing the most aggressive strategy). Furthermore, Campaign A may comprise a standard campaign for the Top 15% and inactive consumer class that has been modified for customer A.

Customer B has been identified, for example by the customer evaluation module 116, as falling within a 15-30% and active consumer class. Based on the 15-30% and active consumer class, the campaign manager module 120 selects Campaign B for exposure to Customer B. In this case, an aggressive strategy has been selected for the 15-30% and active consumer class. Messages A and B and phone communication A may be similar to communications selected for customer A. Similar to Campaign A, Campaign B may comprise any number of messages or communications including a single communication (for example with a medium discount representing the aggressive strategy).

Customer C has been identified, for example by the customer evaluation module 116, as falling within a 90-100% and active consumer class. Based on the 90-100% and active consumer class, the campaign manager module 120 selects Campaign C for exposure to Customer C. In this case, a least aggressive strategy has been selected for Customer C. Message A may be similar to communications selected for customers A and B, e.g. generic advertisement sent to all current and potential customers, or Message A may be specific to customer C. Campaign C may comprise any number of messages or communications including a single communication (for example with a low discount or no discount representing the least aggressive strategy).

### Example Methods

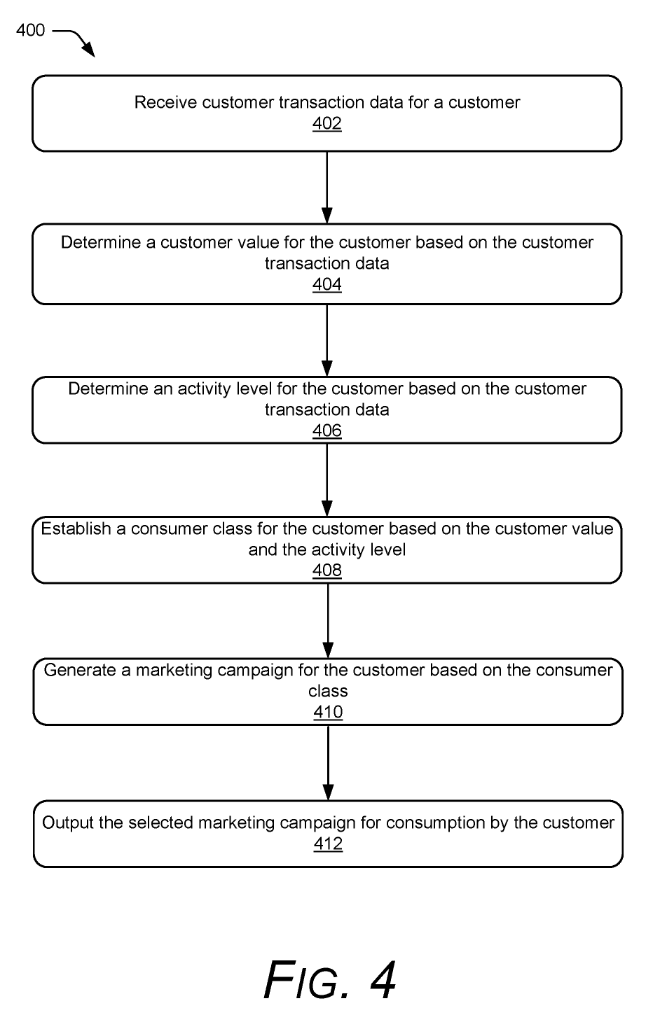

FIG. 4 illustrates a flow diagram at 400 showing methods in an example implementation for determining a marketing campaign for a customer based on customer interaction data. At operation 402, transaction data is received for a plurality of customers. The transaction data may contain customer data for each customer, or the transaction data may be parsed to determine customer data for each customer. In order to parse the transaction data, a receipt reader may be used to link transactions to a customer based on, for example, credit cards used. At operation 404, a customer value for the customer is determined based on the transaction data that is specific to the customer. As discussed above, the customer value may be determined by one or more of comparing transaction data for the customer to other customers, segmenting the transaction data for the customers into groups, calculating dollar amounts spent by the customer, calculating a loyalty value based on transaction frequencies of the customer, and so on. At operation 406, an activity level is determined for the customer that is indicative of current behavior of the customer. The activity level may be based on frequency trends within past transactions of the customer, comparison with other customers, groupings of the customers based on frequencies of transactions and so on. At operation 408, a consumer class for the customer is established based on the customer value and the activity level. For example, the customer may be identified as top 15% and active consumer class, indicating that the customer is within the top 15% of value within the customers and generally active (has not triggered inactive status caused by a lapse in transactions greater than a variation threshold). At operation 410, a campaign is generated based on the consumer class for the customer. A campaign may be selected from a group of pre-determined campaigns or the campaign may be chosen from the group of pre-determined campaigns and then modified or replaced with another campaign based on other information received, such as recent comments from the customer, notes from a manager, a most recent transaction, and so on. Furthermore, the campaigns from which the campaign is chosen may be pre-determined based upon determined consumer classes, demographic information, products offered, pricing of products or services, and so on. In some implementations, the campaign may not be selected from a pre-determined list but generated in real-time based on the transaction data. Furthermore, the campaign may be specific to the customer or more generalized for one or more of the consumer classes. Regardless of whether the campaign is selected from a group or generated, at operation 412, the campaign is output for consumption by the customer.

### Example System and Device

FIG. 5 illustrates an example system generally at 500 that includes an example computing device 502, which is representative of one or more computing systems and/or devices that may implement the various techniques described herein. This is illustrated through inclusion of the marketing service 104, which may be configured to determine appropriate marketing campaigns for customers based on past transaction data of the customer. The computing device 502 may be, for example, a server of a service provider, a device associated with a client (e.g., a client device), an on-chip system, and/or any other suitable computing device or computing system.

The computing device 502 as illustrated includes a processing system 504, one or more computer-readable media 506, and one or more input/output (I/O) interface(s) 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510, which may be configured as processors, functional blocks, and so forth. This may include implementation in hardware as an application-specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user transaction.

Various techniques may be described herein in the general context of software, hardware elements, or program modules. Generally, such modules include routines, programs, objects, elements, components, data structures, and so forth that perform particular tasks or implement particular data types. The entities described herein generally represent software, firmware, hardware, or a combination thereof. The features of the techniques described herein are platform-independent, meaning that the techniques may be implemented on a variety of commercial computing platforms having a variety of processors.

An implementation of the described entities and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and the computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more of the hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or the hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of the platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. The resources 518 can also include services provided over the internet and/or through a subscriber network, such as a cellular or Wi-Fi network.

The platform 516 may abstract resources and functions to connect the computing device 502 with other computing devices. The platform 516 may also serve to abstract scaling of resources to provide a corresponding level of scale to encountered demand for the resources 518 that are implemented via the platform 516. Accordingly, in an interconnected device embodiment, implementation of functionality described herein may be distributed throughout the system 500. For example, the functionality may be implemented in part on the computing device 502 as well as via the platform 516 that abstracts the functionality of the cloud 514.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital marketing environment to generate a marketing campaign for a customer, a method implemented by at least one computing device, the method comprising:
receiving, by the at least one computing device, transaction data that includes respective customer data for the customer and other customers;
determining, by the at least one computing device, a customer value and activity level for the customer based on the customer data;
establishing, by the at least one computing device, a consumer class for the customer based on the determined customer value and activity level for the customer;
generating, by the at least one computing device, the marketing campaign for the customer based on the established consumer class for the customer; and
outputting, by the at least one computing device, the marketing campaign for exposure to the customer.

2. The method of claim 1, wherein the marketing campaign is selected from a group of marketing campaigns.

3. The method of claim 2, wherein the each of the marketing campaigns of the group of marketing campaigns are associated with a respective consumer class.

4. The method of claim 1, wherein the marketing campaign is generated dynamically responsive to determining the consumer class for the customer.

5. The method of claim 1, wherein the marketing campaign is specific to the customer.

6. The method of claim 1, wherein the marketing campaign is generic to the established consumer class.

7. The method of claim 6, further comprising identifying other customers within the consumer class and outputting the marketing campaign for exposure to the other customers.

8. The method of claim 1, wherein the customer value is based on monetary amounts of transactions and frequency of transactions of the customer.

9. The method of claim 1, wherein the activity level for the customer is based on determined frequency trends of historical transactions of the customer.

10. The method of claim 1, wherein the marketing campaign comprises one or more of an email, a text message, a postal advertisement, a phone call, reward points, a free product, a free service, a percentage discount, or a dollar, currency, or other monetary amount discount.

11. In a digital marketing environment to generate a marketing campaign for a customer, a system comprising:
a customer evaluation module implemented at least partially in hardware to determine a consumer class for the customer, the customer evaluation module comprising:
a value determination module implemented at least partially in hardware to:
receive transaction data that includes respective customer data for the customer and other customers; and
determine a customer value for the customer based on monies spent by the customer and transaction frequency for the customer;
a behavior status module implemented at least partially in hardware to:
receive the customer transaction data; and
determine an activity level for the customer based on the transaction frequency for the customer; and
a consumer class module implemented at least partially in hardware to establish the consumer class for the customer based on the determined customer value and determined activity level for the customer; and
a campaign manager module implemented at least partially in hardware to:
generate the marketing campaign for the customer based on the established consumer class for the customer; and
output the marketing campaign for exposure to the customer.

12. The system of claim 11, wherein outputting the marketing campaign comprises interacting, by the campaign manager module, with a remote service.

13. The system of claim 11, wherein the transaction data includes dates of transactions and dollar amounts spent for the customer and/or the other customers.

14. The system of claim 11, wherein the marketing campaign is generated from a group of marketing campaigns that are associated with respective consumer classes.

15. The system of claim 11, wherein the customer value is based on a comparison of the customer data for the customer to the customer data for the other customers.

16. The system of claim 15, wherein the customer value is based on percentage thresholds determined by statistical analysis of the transaction data.

17. The system of claim 11, wherein the activity level comprises an active or inactive state for the customer.

18. One or more computer-readable storage media comprising instructions stored thereon that, responsive to execution by a computing device, causes the computing device to generate a marketing campaign for a customer, the marketing campaign generated by performing operations comprising:
receiving transaction data that includes customer data for the customer and customer data for other customers;
determining a customer value and activity level for the customer based on the transaction data;
establishing a consumer class for the customer based on the determined customer value and activity level for the customer;
generating the marketing campaign for the customer based on the established consumer class for the customer; and
outputting the marketing campaign for exposure to the customer.

19. The one or more computer-readable storage media of claim 18, wherein the customer value is based on one or more of dollars spent or frequency of transactions for the customer relative to one or more of dollars spent or frequency of transactions of the other customers.

20. The one or more computer-readable storage media of claim 18, wherein the marketing campaign is selected from a group of marketing campaigns, and wherein the marketing campaigns are associated with respective consumer classes.
